(19) United States
(12) Patent Application Publication
(10) Pub. No.: US 2012/0090188 A1
(43) Pub. Date: Apr. 19, 2012

(54) MEASURING DEVICE FOR DETERMINING A THREAD LENGTH OF A FASTENER

(76) Inventor: Peter J.H. Chang, Taipei (TW)

(21) Appl. No.: 13/115,769

(22) Filed: May 25, 2011

(30) Foreign Application Priority Data
Oct. 14, 2010 (TW) 099219816

(51) Int. Cl. G01B 5/02

(52) U.S. Cl. 33/833

(57) ABSTRACT

A measuring device is adapted for determining a thread length of a fastener required for fastening a wheel onto a wheel hub unit. The measuring device includes a measuring rod extending straightly to terminate at front and rear surfaces, a positioning member secured to the front surface to mate with an abutment seat of a bolt hole in the wheel so as to measure a length of the bolt hole, and an anchor member secured to the rear surface and extending perpendicularly to be brought into abutment with a flange surface of the wheel hub unit so as to measure a thread length of a threaded bolt or bore.

### CROSS-REFERENCE TO RELATED APPLICATION

This application claims priority of Taiwanese Application No. 099219816, filed on Oct. 14, 2010, the disclosure of which is herein incorporated by reference.

### BACKGROUND OF THE INVENTION

1. Field of the Invention

This invention relates to a measuring device, more particularly to a measuring device adapted for determining a thread length of a fastener required for fastening a wheel onto a wheel hub unit.

2. Description of the Related Art

Wheels for vehicles are generally classified as two basic types: U.S. and Japan standard and European standard. A wheel under the U.S. and Japan standard generally includes a wheel hub formed with a plurality of threaded bolts at a hub flange thereof. The threaded bolts are disposed to extend through a plurality of bolt holes in a wheel rim and are threadedly engaged with a plurality of lug nuts to fasten the wheel rim onto the wheel hub. A wheel under European standard generally includes a wheel hub formed with a plurality of threaded bores such that a plurality of lug bolts extend through a plurality of bolt holes in a wheel rim and are threadedly engaged with the threaded bores to fasten the wheel rim onto the wheel hub.

In the event of wheel replacement, it is required to determine the threaded lengths of the lug nuts (or the lug bolts) and the bolt holes in the wheel rim to ensure a secured engagement of the lug nuts (or the lug bolt) with the threaded bolts (or the threaded bores), thereby replacing appropriate wheel rim and lug nuts (or lug bolts). However, measuring the length of the threaded bolts (or the depth of the lug bolts) of the wheel hub that is affixed on the vehicle is difficult. Therefore, it is necessary to have a measuring device for measuring the lengths of lug bolts or lug nuts on a wheel hub, and of bolt holes in a wheel rim for the sake of safety.

### SUMMARY OF THE INVENTION

Therefore, the object of the present invention is to provide a measuring device which facilitates measuring of the lengths of lug bolts or lug nuts on a wheel hub, and of bolt holes in a wheel.

Accordingly, the measuring device of this invention includes an elongated measuring rod, a positioning member, and an anchor member. The elongated measuring rod extends straight along a lengthwise axis to terminate at front and rear surfaces, and has front and rear graduated segments proximate to the front and rear surfaces, respectively. The positioning member is secured to the front surface and is configured to mate with a circumferential abutment seat on an outer major surface of a wheel such that the elongated measuring rod extends through a bolt hole in the wheel so as to measure the length of the bolt hole. The anchor member is secured to the rear surface, and extends perpendicularly from and beyond the rear surface. The anchor member has an anchoring surface configured to be brought into abutment with an inner flange surface of a wheel hub unit when the elongated measuring rod extends through a threaded bore in the wheel hub unit so as to measure the length of the threaded bore.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a wheel and a wheel hub unit of U.S. and Japanese standard;

FIG. 2 is a perspective view of a wheel and a wheel hub unit of European standard;

FIG. 3 is a perspective view of a first preferred embodiment of a measuring device according to the present invention;

FIG. 4 is a side view of the first preferred embodiment;

FIG. 5 is a front view of the first preferred embodiment;

FIG. 6 is a rear view of the first preferred embodiment;

FIG. 7 is a schematic side view illustrating how the length of a threaded bolt of a wheel hub unit is measured using the measuring device of the first preferred embodiment;

FIG. 8 is a schematic side view illustrating how the length of a threaded bore of a wheel hub unit is measured using the measuring device of the first preferred embodiment;

FIG. 9 is a schematic sectional side view illustrating how the length of a bolt hole of a wheel is measured using the measuring device of the first preferred embodiment;

FIG. 10 is a front view of a second preferred embodiment of a measuring device according to the present invention; and

FIG. 11 is a rear view of the second preferred embodiment.

### DETAILED DESCRIPTION OF THE PREFERRED EMBODIMENTS

Before the present invention is described in greater detail, it should be noted that like reference numerals are used to indicate corresponding or analogous elements throughout the accompanying disclosure.

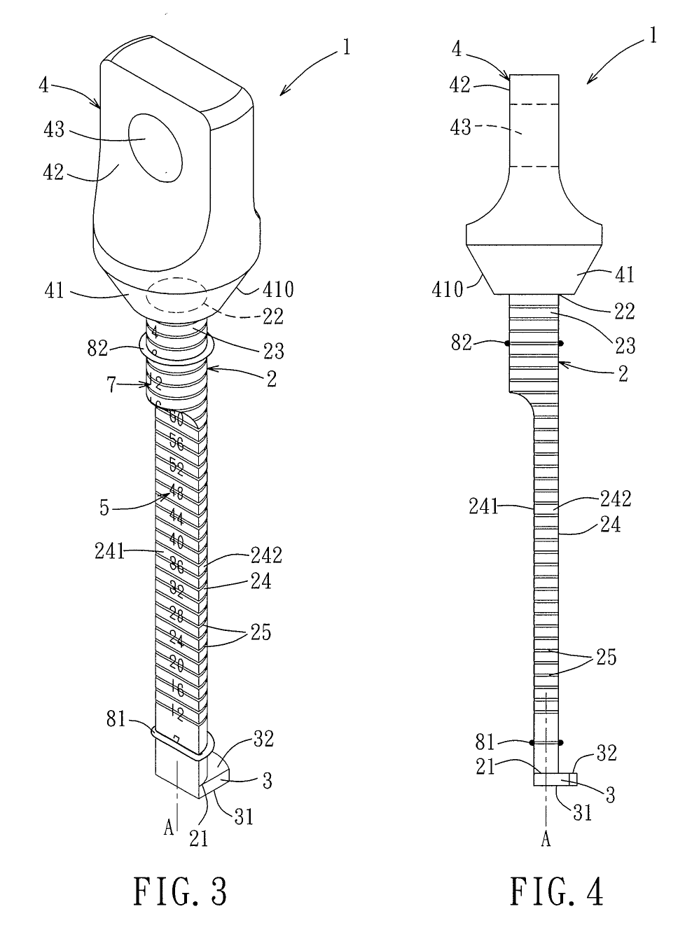

As shown in FIGS. 3 to 6, a first preferred embodiment of a measuring device 1 of this invention is adapted for determining a thread length of a lug nut 93 or a lug bolt 95 required for fastening a wheel 92 onto a wheel hub unit 91, 94.

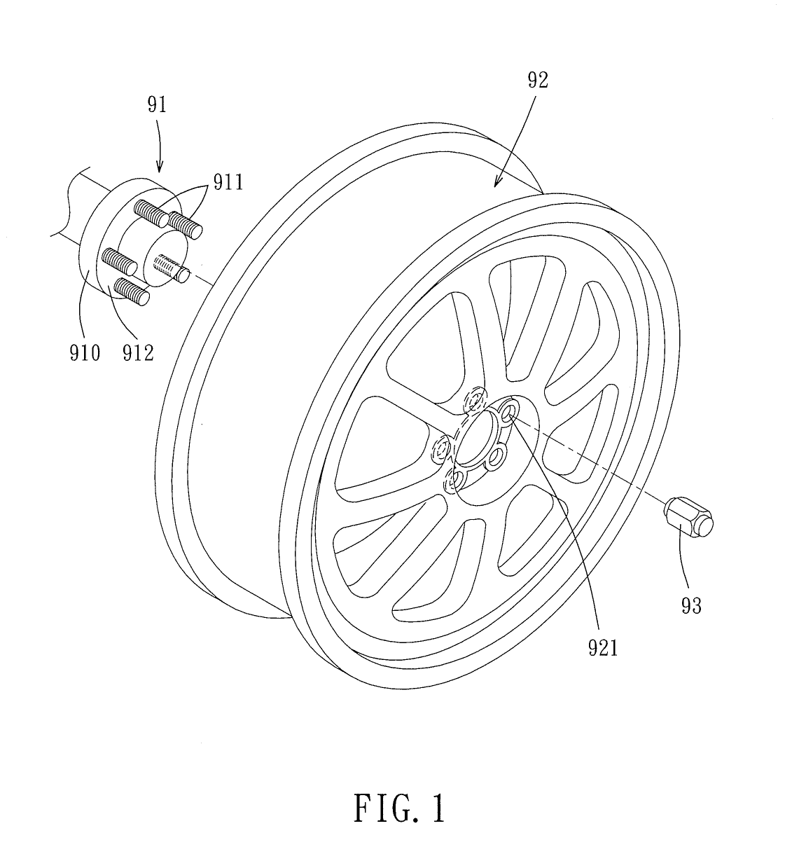

Specifically, referring to FIG. 1, a wheel assembly under the U.S. and Japan standard includes a wheel hub unit 91 having a hub flange 910 formed with a plurality of threaded bolts 911 that extend from an outer flange surface 912, and a wheel 92 having a plurality of bolt holes 921 that extend therethrough such that a plurality of lug nuts 93 (only one is shown) extend through the lug nuts 93 for threaded engagement with the threaded bolts 911.

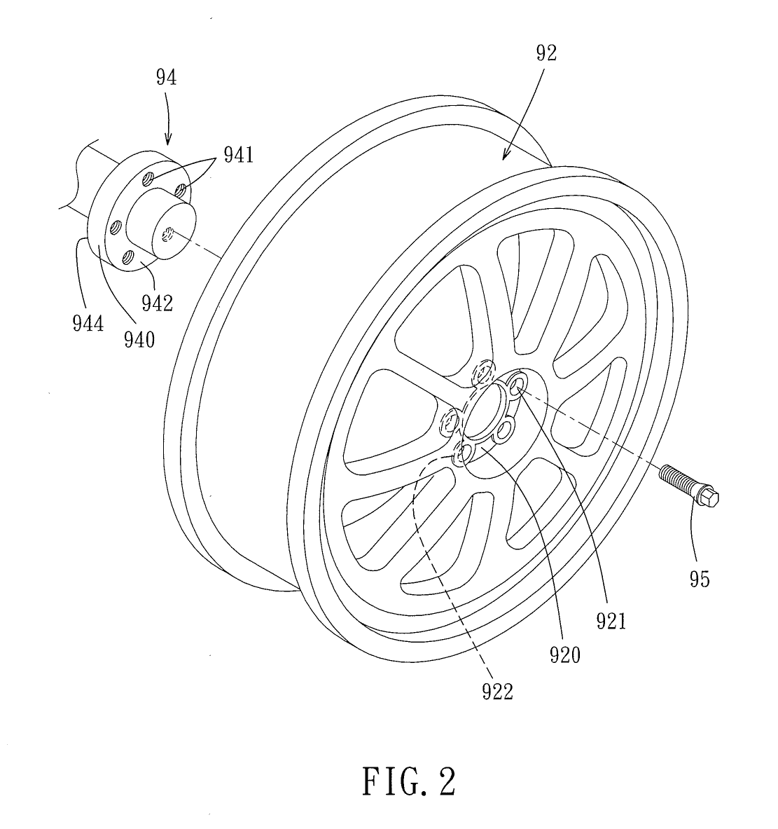

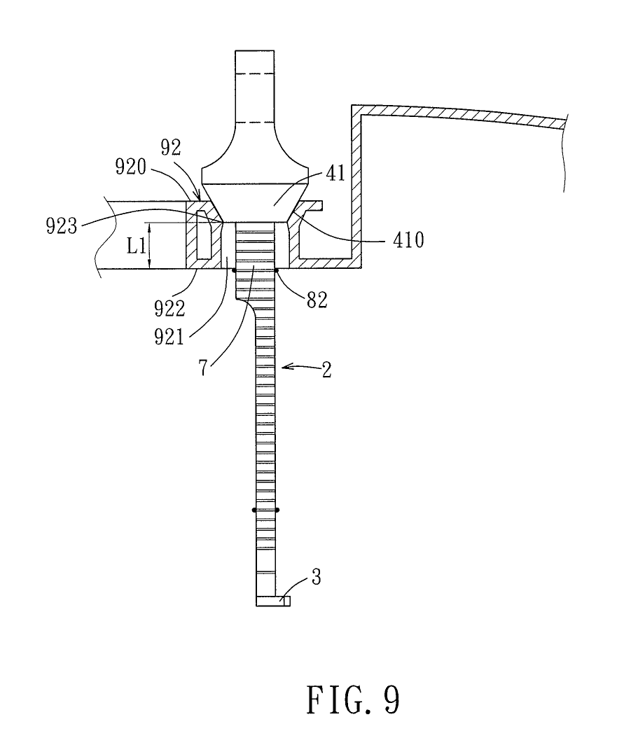

Referring to FIG. 2, a wheel assembly under the European standard includes a wheel hub unit 94 having a flange 940 formed with a plurality of threaded bores 941 that extend through outer and inner flange surfaces 942, 944 of the flange 940, and a wheel 92 having a plurality of bolt holes 921 that extend through inner and outer major surfaces 920, 922 thereof such that a plurality of lug bolts 95 (only one is shown) extend through the bolt holes 921 for threaded engagement with the threaded bores 941. In addition, as shown in FIG. 9, each of the bolt holes 921 has a first axial length (L1). The outer major surface 920 has an enlarged hole which is larger in diameter than the respective bolt hole 921 so as to define a circumferential abutment seat 923.

The measuring device 1 according to the first embodiment is shown to comprise an elongated measuring rod 2, a positioning member 4, an anchor member 3, and two indicating members 81, 82.

The elongated measuring rod 2 extends straight along a lengthwise axis (A) to terminate at front and rear surfaces 22, 21, and has front and rear graduated segments 23, 24 that are proximate to the front and rear surfaces 22, 21, respectively.

The positioning member 4 is secured to the front surface 22 and includes a mating segment 41 and a handgrip 42. The mating segment 41 is divergent from the front surface 22 and has a rearward facing surface 410 for mating of the positioning member 4 with the circumferential abutment seat 923 (see FIG. 9), such that a first linear relationship is established between the front graduated segment 23 and the first axial length (L1). The handgrip 42 is disposed to extend from the mating segment 41 away from the front surface 22 and is formed with a hole 43 for hanging up the measuring device 1. In this embodiment, the mating segment 41 is of a frustoconical shape.

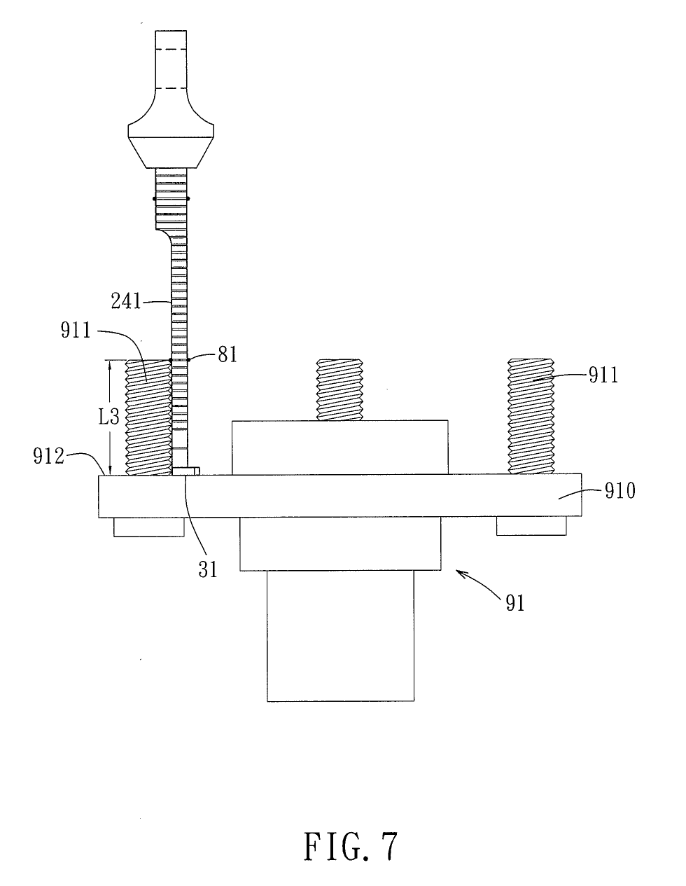

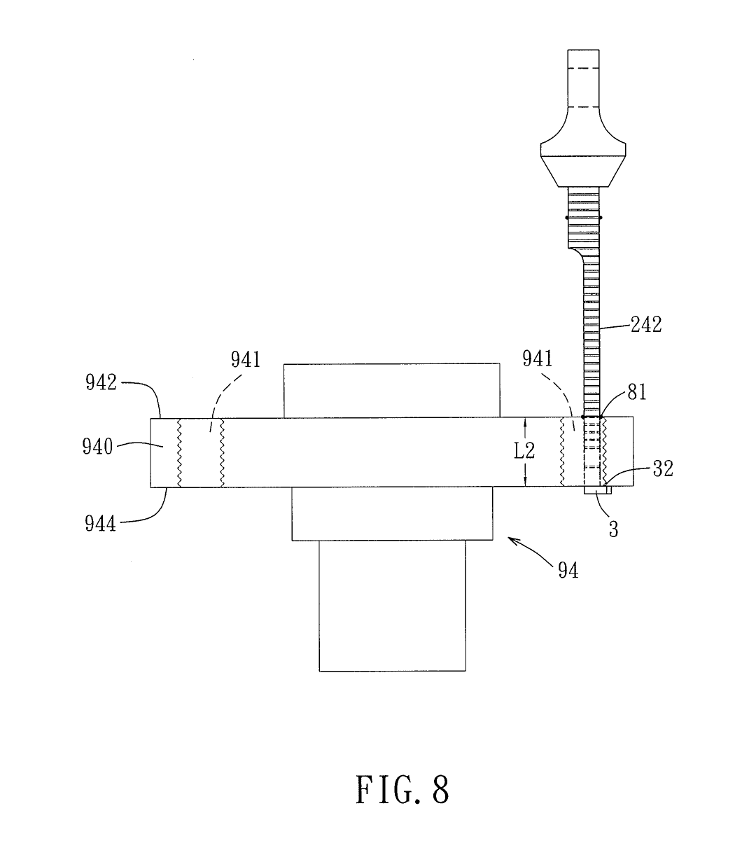

The anchor member 3 is secured to the rear surface 21, extends perpendicularly from and beyond the rear surface 21, and has an abutment surface 31 and an anchoring surface 32. The anchoring surface 32 is configured to be brought into abutment with the inner flange surface 944 (see FIG. 8) to establish a second linear relationship between the rear graduated segment and the second thread length (L2). The abutment surface 31 is parallel and opposite to the anchoring surface 32 in a direction of the lengthwise axis (A), and is adapted to be brought into abutment with the outer flange surface 912 (see FIG. 7).

The rear graduated segment 24 of the elongated measuring rod 2 is configured to have a flat abutment surface 241 and a rounded abutment surface 242. The flat abutment surface 241 extends along the lengthwise axis (A), and is adapted to abut against the threaded bolt 911 (see FIG. 7) such that a third linear relationship between the rear graduated segment 24 and a length (L3) of the threaded bolt 911 is established. The rounded abutment surface 242 is opposite to the flat abutment surface 241 transversely relative to the direction of the lengthwise axis (A), and is configured to extend along the lengthwise axis (A) such that, when the anchoring surface 32 is brought to abut against the inner flange surface 944 of the wheel hub unit 94 (see FIG. 8), the rounded abutment surface 242 is brought to abut against an inner bore surface of the threaded bore 941 through the entire second thread length (L2).

The front and rear graduated segments 23, 24 of the elongated measuring rod 2 are formed with a plurality of ring grooves 25 displaced from one another along the lengthwise axis (A).

The indicating members 81, 82 are disposed respectively on the front and rear graduated segments 23, 24 and are movable along the lengthwise axis (A) to two selected ones of the ring grooves 25, respectively.

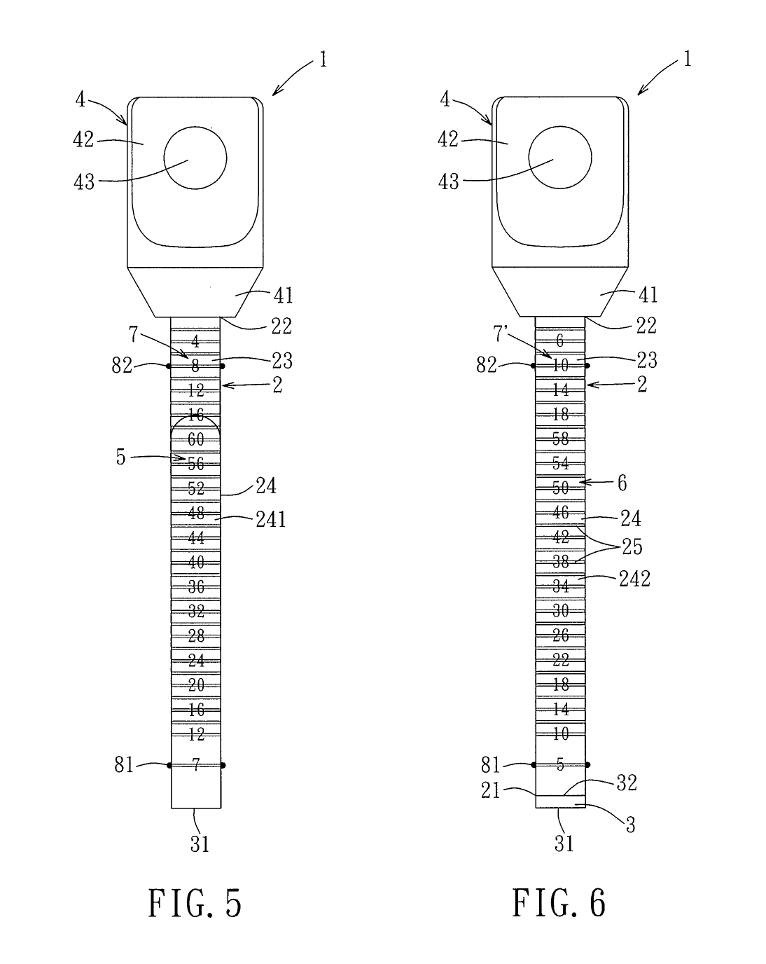

Further referring to FIG. 7, to measure the length (L3) of the threaded bolt 911, the abutment surface 31 is brought to abut against the outer flange surface 912 of the hub flange 910, the flat abutment surface 241 is brought to abut against the threaded bolt 911, and the indicating member 81 is moved to be aligned with the end of the threaded bolt 911 so as to obtain the length (L3) of the threaded bolt 911. For example, as shown in FIG. 5, a first graduated scale 5 is marked on the rear graduated segment 24 with a zero point indicated at the abutment surface 31. Specifically, the first graduation of the first graduated scale 5 started from the abutment surface 31 is marked as 7 mm, the second graduation is marked as 12 mm, the rest of the graduations are displaced at intervals of 2 mm, and every two of the rest graduations are marked with a number. Since, in practice, the length (L3) of the threaded bolt 911 is usually smaller than 60 mm, the maximum number marked on the first graduated scale 5 is 60 mm.

Further referring to FIG. 8, to measure the second thread length (L2) of the threaded bore 941 of the hub flange 940, the anchor member 3 is firstly brought to extend through the threaded bore 941 until the anchoring surface 32 is brought to abut against the inner flange surface 944. The rounded abutment surface 242 is brought to abut against the inner bore surface of the threaded bore 941 through the entire second thread length (L2). Subsequently, the indicating member 81 is moved to align with the outer flange surface 942 so as to obtain the second thread length (L2). For example, as shown in FIG. 6, a second graduated scale 6 is marked on the rear graduated segment 24 with a zero point indicated at the anchoring surface 32. Specifically, the first graduation of the second graduated scale 6 started from the anchoring surface 32 is marked as 5 mm, the second graduation is marked as 10 mm, the rest of the graduations are displaced at intervals of 2 mm, and every two of the graduations are marked with a number. Although the maximum number marked on the second graduated scale 6 as depicted is 58 mm, the second graduated scale 6 can measure up to 60 mm. It should be noted that, in this embodiment, graduations on the first and second graduated scales 5, 6 are aligned with each other, and the distance between the abutment surface 31 and the anchoring surface 32 is equal to 2 mm.

Further referring to FIG. 9, to measure the first axial length (L1) of the bolt hole 921 of the wheel 92, the anchor member 3 and the elongated measuring rod 2 are firstly brought to extend through the bolt hole 921, and the rearward facing surface 410 of the mating segment 41 abuts matingly the circumferential abutment seat 923. Thereafter, the indicating member 82 is moved to align with the outer major surface 922 of the wheel 92 so as to obtain the first axial length (L1). For example, as shown in FIG. 5, a third graduated scale 7 is marked on the front graduated segment 23 with a zero point indicated at the front surface 22. The first graduation of the third graduated scale 7 started from the front surface 22 is marked as 4 mm, the rest of the graduations are displaced at intervals of 2 mm, and every two of the graduations are marked with a number. In practice, the axial length (L1) of the bolt hole 921 usually ranges from 4 mm to 18 mm. Hence, the second graduated scale 6 can measure up to 18 mm although the maximum number marked on the third graduated scale 7 is 16 mm.

Furthermore, as shown in FIG. 6, a fourth graduated scale 7′ is marked on the rear graduated segment 24 opposite to the third graduated scale 7. The first graduation of the fourth graduated scale 7′ is marked as 6 mm (2 mm of difference from the first graduation of the fourth graduated scale). The third graduated scale 7 is suitable for measuring the bolt hole 921 of 12 mm in diameter, and the fourth graduated scale 7′ is suitable for measuring the bolt hole 921 of 14 mm in diameter.

It can be appreciated that each graduation of the third graduated scale 7 is aligned with each graduation of the fourth graduated scale 7′ at each ring groove 25, and each graduation of the first scale 5 is aligned with each graduation of the second scale 6 at each ring groove 25.

Therefore, the first axial length (L1), the second thread length (L2), and the length (L3) of the threaded bolt 911 can be identified easily by virtue of the indicating members 81, 82.

When it is desired to fasten the wheel 92 on the wheel hub unit 91, the required thread length of the lug nut 93 can be determined in accordance with the length (L3) and the first axial length (L1). When it is desired to fasten the wheel 92 on the wheel hub unit 94, the required thread length of the lug bolt 95 can be determined in accordance with the second thread length (L2) and the thread length (L1).

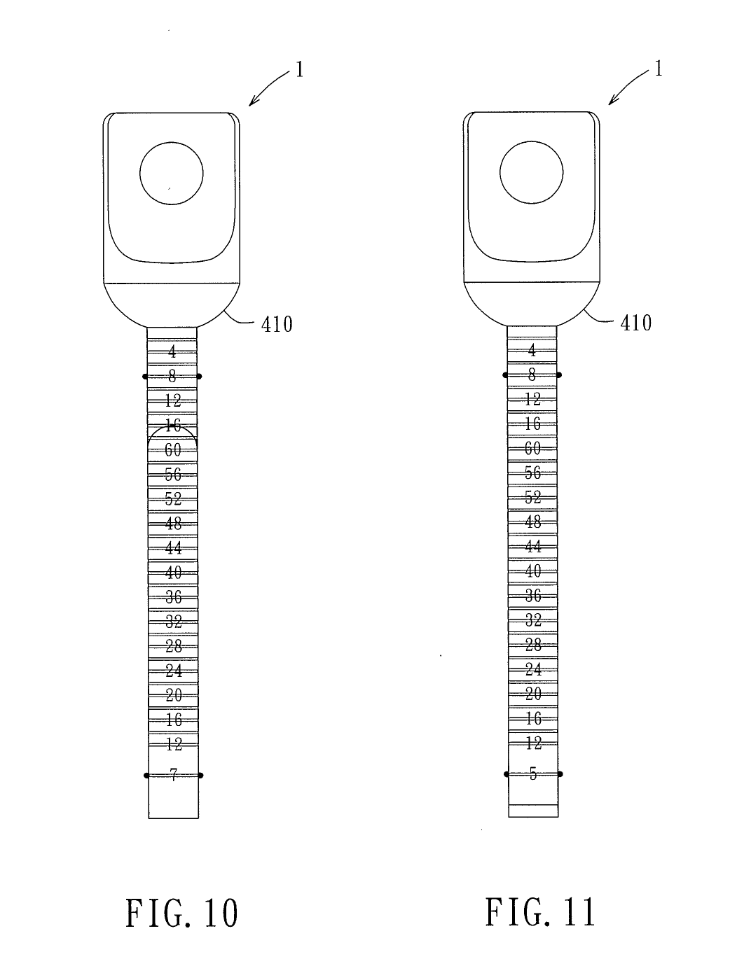

Referring to FIGS. 10 and 11, a second preferred embodiment of the measuring device 1 of the present invention is shown. The main difference between the second embodiment and the first embodiment resides in that the rearward facing surface 410 is of a curved shape that abuts fittingly against the circumferential abutment seat (not shown) that has a curved profile, and the fourth graduated scale 7′ is dispensed with herein.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A measuring device adapted for determining a thread length of a fastener required for fastening a wheel onto a wheel hub unit, the wheel being formed with a bolt hole which extends through inner and outer major surfaces thereof and which has a first axial length, the outer major surface having an enlarged hole which is larger in diameter than the bolt hole so as to define a circumferential abutment seat, the wheel hub unit having a hub flange which is formed with one of a threaded bore and a threaded bolt that respectively extend from inner and outer flange surfaces to have second and third thread lengths for threaded engagement with the fastener, said measuring device comprising:
an elongated measuring rod which extends straight along a lengthwise axis to terminate at front and rear surfaces, and which has front and rear graduated segments that are proximate to said front and rear surfaces, respectively;
a positioning member secured to said front surface and configured to mate with the circumferential abutment seat such that a first linear relationship is established between said front graduated segment and the first axial length; and
an anchor member secured to said rear surface, and extending perpendicularly from and beyond said rear surface, said anchor member having an anchoring surface that is configured to be brought into abutment with the inner flange surface to establish a second linear relationship between said rear graduated segment and the second thread length.

2. The measuring device as claimed in claim 1, wherein said positioning member includes a mating segment which is divergent from said front surface, and which has a rearward facing surface for mating of said positioning member with the circumferential abutment seat.

3. The measuring device as claimed in claim 2, wherein said positioning member further has a handgrip disposed to extend from said mating segment away from said front surface.

4. The measuring device as claimed in claim 3, wherein said handgrip of said positioning member is formed with a hole for hanging up the measuring device.

5. The measuring device as claimed in claim 1, wherein said anchor member has an abutment surface which is parallel and opposite to said anchoring surface in a direction of the lengthwise axis, and which is adapted to be brought into abutment with the outer flange surface, said rear graduated segment of said elongated measuring rod being configured to have a flat abutment surface which extends along the lengthwise axis, and which is adapted to abut against the threaded bolt such that a third linear relationship between said rear graduated segment and a length of the threaded bolt is established.

6. The measuring device as claimed in claim 5, wherein said rear graduated segment of said elongated measuring rod has a rounded abutment surface which is opposite to said flat abutment surface transversely relative to the direction of the lengthwise axis, and which is configured to extend along the lengthwise axis such that when said anchoring surface is brought to abut against the inner flange surface of the wheel hub unit, said rounded abutment surface is brought to abut against an inner bore surface of the threaded bore through the entire second thread length.

7. The measuring device as claimed in claim 1, wherein said front and rear graduated segments of said elongated measuring rod are formed with a plurality of ring grooves displaced from one another along the lengthwise axis, said measuring device further comprising two indicating members disposed respectively on said front and rear graduated segments and movable along the lengthwise axis to two selected ones of said ring grooves, respectively.
